(19) United States
(12) Patent Application Publication
(10) Pub. No.: US 2025/0313058 A1
(43) Pub. Date: Oct. 9, 2025

(54) THERMAL SYSTEM FOR AN ELECTRIC VEHICLE

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 19/241,974

(22) Filed: Jun. 18, 2025

Related U.S. Application Data
(63) Continuation of application No. PCT/EP2023/083909, filed on Dec. 1, 2023.

(30) Foreign Application Priority Data
Dec. 20, 2022 (DE) 10 2022 134 028.7

(51) Int. Cl. B60H 1/00

(52) U.S. Cl. CPC B60H 1/00392; B60H 1/00278

(57) ABSTRACT

A thermal system for an electric vehicle, including a refrigerant circuit, a first coolant circuit to which a heat source and, upstream from the heat source, an ambient cooler, are connected. A second coolant circuit to which a high-voltage store and a chiller are connected in a heat-transmitting manner. A first switching state is settable in which the second coolant circuit is connected to the first coolant circuit downstream from and upstream from the heat source in such a way that coolant can flow through the high-voltage store and the heat source in series. In addition to the first switching state, a second switching state of the thermal system is settable in which, downstream from the high-voltage store, the second coolant circuit is connected both to the heat source and to the chiller, wherein coolant can flow through the heat source and the chiller, which are connected in parallel.

This nonprovisional application is a continuation of International Application No. PCT/EP2023/083909, which was filed on Dec. 1, 2023, and which claims priority to German Patent Application No. 10 2022 134 028.7, which was filed in Germany on Dec. 20, 2022, and which are both herein incorporated by reference.

### BACKGROUND OF THE INVENTION

### Field of the Invention

The present invention relates to a thermal system for an electric vehicle.

### Description of the Background Art

Thermal systems are known from the prior art in different variants, and comprise a refrigerant circuit, a first coolant circuit to which at least one heat source of the electric vehicle and, upstream from the heat source, an ambient cooler of the electric vehicle, are connected in a heat-transmitting manner for heat exchange with the free surroundings, and a second coolant circuit to which a high-voltage store for supplying energy to an electric drive train of the electric vehicle and a chiller are connected in a heat-transmitting manner, wherein the chiller is also connected to the refrigerant circuit in a heat-transmitting manner for heat transfer from the second coolant circuit to the refrigerant circuit, and a first switching state of the thermal system is settable in which, downstream from and upstream from the heat source, the second coolant circuit is connected to the first coolant circuit, so that coolant can flow through the high-voltage store and the heat source in series for heating the high-voltage store by means of the heat source.

### SUMMARY OF THE INVENTION

It is therefore an object of the present invention to improve a thermal system for an electric vehicle.

This object is achieved by a thermal system, which is characterized in that in addition to the first switching state of the thermal system, a second switching state of the thermal system can be settable in which, downstream from the high-voltage store, the second coolant circuit is connected both to the heat source and to the chiller, wherein coolant can flow through the heat source and the chiller, which are connected in parallel. The term “electric vehicle” can be interpreted here in a general sense, and encompasses any type of electric vehicle, i.e., also hybrid vehicles with an electric motor on the one hand and an internal combustion engine on the other hand. The subclaims relate to advantageous refinements of the invention.

A significant advantage of the thermal system according to the invention in particular is that a thermal system for an electric vehicle is improved. Due to the provision according to the invention of the thermal system for an electric vehicle, for example the heat that is withdrawn from the coolant system by the chiller may be at least partially compensated for by the heat source, so that the high-voltage store is either cooled or warmed by the coolant flowing out of the heat source and into the chiller. In addition, it is conceivable for the heat release by the heat source and the heat withdrawal by the chiller to be coordinated with one another in such a way that the coolant flowing into the high-voltage store has the same temperature as that of the high-voltage store, and the high-voltage store accordingly neither absorbs nor releases heat.

The thermal system according to the invention for an electric vehicle is freely selectable within suitable ranges with respect to the type, mode of operation, material, and dimensioning.

The heat source can be designed as a component of the drive train of the electric vehicle. In this way, by use of the thermal system according to the invention the drive train, i.e., an electric motor that is supplied with energy by the high-voltage store for driving the electric vehicle, and power electronics corresponding to the electric motor on the one hand are coolable to a required extent, and on the other hand are usable as a heat source for heating other components of the thermal system according to the invention.

A further advantageous refinement of the thermal system according to the invention provides that at the first coolant circuit, in addition a first internal radiator for heat transfer is connected to an interior of the electric vehicle in a heat-transmitting manner, and preferably that the first internal radiator can be selectively connectable to a remainder of the first coolant circuit or is disconnectable from this remainder, and particularly preferably that a condenser of the refrigerant circuit is situated upstream from the first internal radiator in a heat-transmitting manner. By use of the coolant circuits, i.e., the coolant system, direct heating and/or cooling of the interior of the electric vehicle, i.e., a passenger compartment of the electric vehicle, is thus also made possible. The example of this refinement of the thermal system according to the invention also has the further advantage that the refrigerant circuit of the thermal system according to the invention, in addition to the chiller, is connected in a heat-transmitting manner to the coolant circuits by means of the condenser.

Another advantageous refinement of the thermal system according to the invention provides that the thermal system, in addition to the first and second coolant circuits, has a third coolant circuit to which, besides the chiller and the ambient cooler, a second internal radiator for heat transfer between the third coolant circuit and the interior of the electric vehicle is connected in a heat-transmitting manner, and preferably that the second internal radiator is selectively connectable to a remainder of the third coolant circuit or is disconnectable from this remainder. A further option is thus provided for the direct heat transfer between the coolant circuits and the interior of the electric vehicle.

An advantageous refinement of the thermal system provides that the thermal system is designed in such a way that a third switching state of the thermal system can be settable, wherein in the third switching state, coolant can flow separately, firstly through the second coolant circuit with the high-voltage store and the chiller, secondly through the third coolant circuit with the chiller and the second internal radiator, and thirdly through the first coolant circuit with the ambient cooler and the drive train. In this way the cold coolant of the chiller can cool the interior and the high-voltage store, i.e., a vehicle battery. Whereas coolant can flow through the first coolant circuit with the ambient cooler, for example a front-end radiator, and the drive train, i.e., with the heat sources, the first internal radiator is isolated from heat transfer, for example by means of air flaps, so that the heat from the refrigerant system, which previously had been withdrawn from the coolant in the chiller, may be released to the free surroundings by means of the ambient cooler. In addition, the cooled coolant from the ambient cooler cools the drive train.

The thermal system can be designed in such a way that a fourth switching state of the thermal system can be settable, wherein in the fourth switching state, coolant can flow separately, on the one hand through the second coolant circuit with the high-voltage store and the chiller, and on the other hand through the first coolant circuit with the ambient cooler and the drive train. The cold coolant of the chiller can cool the high-voltage store in this way. The first internal radiator in turn is isolated from heat transfer, so that the heat from the refrigerant system, which previously had been withdrawn from the coolant in the chiller, may be released to the free surroundings by means of the ambient cooler. In addition, the cooled coolant from the ambient cooler cools the drive train.

The thermal system can also be designed in such a way that a fifth switching state of the thermal system can be settable, wherein in the fifth switching state, coolant can flow separately, on the one hand through the third coolant circuit with the chiller and the second internal radiator, and on the other hand through the first coolant circuit with the ambient cooler and the drive train. In this way, the interior is cooled by the cold coolant of the chiller. In turn, the first internal radiator is isolated from heat transfer, so that the heat from the refrigerant system, which previously had been withdrawn from the coolant in the chiller, may be released to the free surroundings by means of the ambient cooler. In addition, the cooled coolant from the ambient cooler cools the drive train.

Further, the thermal system can be designed in such a way that a sixth switching state of the thermal system can be settable, wherein in the sixth switching state, coolant can flow only through the first coolant circuit with the ambient cooler, and the drive train. Thus, coolant flows only through the ambient cooler and the drive train, while the first internal radiator, for example with the above-mentioned air flap, is in turn isolated from heat transfer, so that the heat from the drive train may be released to the free surroundings by means of the ambient cooler.

The thermal system can also be designed in such a way that a seventh switching state of the thermal system is settable, wherein in the seventh switching state, coolant can flow on the one hand through the third coolant circuit with the chiller and the second internal radiator, and on the other hand, coolant can flow jointly through the first coolant circuit with the ambient cooler and the drive train, and the second coolant circuit which has the high-voltage store. The cold coolant of the chiller can thus cool the interior. Whereas the first and second coolant circuits are connected to one another in a coolant-conducting manner, the first internal radiator in turn is isolated from heat transfer, so that the heat from the refrigerant system, which previously had been withdrawn from the coolant in the chiller, may be released to the free surroundings by means of the ambient cooler. In addition, the cooled coolant from the ambient cooler also cools the drive train. Furthermore, the high-voltage store can absorb heat from the drive train. For this purpose, the cooling power of the ambient cooler may be reduced via suitable measures, for example closable air flaps in the front end of the electric vehicle, so that the heat absorption of the second coolant circuit is improved.

The thermal system can be designed in such a way that an eighth switching state of the thermal system can be settable, wherein in the eighth switching state, on the one hand the first coolant circuit with the ambient cooler and the drive train, and on the other hand the second coolant circuit which has the high-voltage store, are connected to one another in a coolant-conducting manner by means of the drive train, and coolant can flow jointly through them. The first and second coolant circuits thus form a joint coolant circuit, the first internal radiator in turn being isolated from heat transfer so that the heat from the drive train may be released to the surroundings by means of the ambient cooler. Since the second coolant circuit is likewise connected to the drive train, the high-voltage store can also absorb heat from the drive train. For this purpose, the cooling power of the ambient cooler may be reduced via suitable measures, for example closable air flaps in the front end of the electric vehicle, so that the heat absorption of the second coolant circuit is improved.

The thermal system may also be designed in such a way that a ninth switching state of the thermal system can be settable, wherein in the ninth switching state, coolant can flow separately, firstly through the third coolant circuit with the second internal radiator, the ambient cooler, and the chiller, secondly through the second coolant circuit which has the high-voltage store, together with the drive train, and thirdly, coolant can flow, separately therefrom, through the first internal radiator. In this way, on the one hand the air for the interior may initially be cooled for the purpose of drying the air in the surroundings, and on the other hand the coolant in the ambient cooler may be warmed by the ambient air in the free surroundings. In the first coolant circuit, the heat that has been withdrawn from the air in the surroundings is then delivered to the interior via the first internal radiator for the purpose of heating the interior. Since the high-voltage store is also connected to the drive train here, the high-voltage store is in turn warmed by the drive train.

The thermal system can be designed in such a way that a tenth switching state of the thermal system can be settable, wherein in the tenth switching state, coolant can flow separately, firstly through the third coolant circuit with the chiller and the ambient cooler, secondly through the second coolant circuit which has the high-voltage store, together with the drive train, and thirdly, coolant can flow, separately therefrom, through the first internal radiator. The coolant in the ambient cooler may thus be heated by the ambient air. In the first coolant circuit, the heat that has been withdrawn from the air in the surroundings is then delivered to the interior via the first internal radiator for the purpose of heating the interior. The high-voltage store, which is connected to the drive train in a coolant-conducting manner, in turn is heated by the drive train.

An eleventh switching state of the thermal system can be settable, wherein in the eleventh switching state, coolant can flow separately, firstly through the third coolant circuit with the chiller and the second internal radiator, secondly through the second coolant circuit which has the high-voltage store, together with the drive train, and thirdly, coolant can flow, separately therefrom, through the first internal radiator. In this way, the air in the surroundings for the interior may initially be cooled for the purpose of drying the air. In the first coolant circuit, the heat that has been withdrawn from the air in the surroundings is then delivered to the interior via the first internal radiator for the purpose of heating. The high-voltage store, which is connected to the drive train in a coolant-conducting manner, in turn is heated by the drive train.

Further, the thermal system can be designed in such a way that a twelfth switching state of the thermal system is settable, wherein in the twelfth switching state, coolant can flow separately, firstly through the third coolant circuit with the chiller, the second internal radiator, and the ambient cooler, secondly through the second coolant circuit which has the high-voltage store, together with the chiller and the drive train, and thirdly, coolant can flow, separately therefrom, through the first internal radiator, and a heater of the electric vehicle for heating the coolant is preferably connected to the second coolant circuit, upstream from the high-voltage store. In this way, on the one hand the air in the surroundings for the interior may initially be cooled for the purpose of drying the air, and on the other hand the coolant in the ambient cooler may be warmed by the ambient air. Since the second coolant circuit is connected both to the chiller and to the drive train, the waste heat from the drive train may be mixed with the cold coolant from the chiller upstream from the high-voltage store. The mixing ratio between coolant from the drive train and coolant from the chiller is selectable based on the temperature requirements for the high-voltage store, so that an inlet temperature of the coolant flowing into the high-voltage store either heats or cools the high-voltage store or has the same temperature as the high-voltage store itself. In addition, a heater, for example an electric auxiliary heater, may additionally deliver heat to the coolant, so that particularly cold coolant, for example when the chiller is operated with very high cooling power, may be appropriately warmed. In the first coolant circuit, the heat that has been withdrawn from the air in the surroundings, and from the drive train and optionally from the high-voltage store and optionally from the above-mentioned heater, is then delivered via the first internal radiator to the interior in order to warm same.

The thermal system can be designed in such a way that a thirteenth switching state of the thermal system can be settable, wherein in the thirteenth switching state, coolant can flow separately, firstly through the third coolant circuit with the chiller and the ambient cooler, secondly through the second coolant circuit which has the high-voltage store, together with the chiller and the drive train, and thirdly, coolant can flow, separately therefrom, through the first internal radiator, and a heater of the electric vehicle for heating the coolant is preferably connected to the second coolant circuit, upstream from the high-voltage store. The coolant in the ambient cooler may thus be warmed by the ambient air. Since the second coolant circuit in turn is connected both to the chiller and to the drive train, waste heat from the drive train may be mixed with the cold coolant from the chiller upstream from the high-voltage store. The mixing ratio between coolant from the drive train and coolant from the chiller is selectable based on the temperature requirements for the high-voltage store, so that an inlet temperature of the coolant flowing into the high-voltage store either heats or cools the high-voltage store or is the same as the high-voltage store itself. Furthermore, the above-mentioned heater may additionally deliver heat to the coolant, so that particularly cold coolant, namely, when the chiller is operated with very high cooling power, may be appropriately warmed. In the first coolant circuit, the heat that has been withdrawn from the air in the surroundings, and from the drive train and optionally from the high-voltage store and optionally the heater, is then delivered via the first internal radiator to the interior in order to warm same.

The thermal system can also be designed in such a way that a fourteenth switching state of the thermal system can be settable, wherein in the fourteenth switching state, coolant can flow separately, firstly through the third coolant circuit with the chiller and the second internal radiator, secondly through the second coolant circuit which has the high-voltage store, together with the chiller and the drive train, and thirdly, coolant can flow, separately therefrom, through the first internal radiator, and a heater of the electric vehicle for heating the coolant is preferably connected to the second coolant circuit, upstream from the high-voltage store. The air in the surroundings may thus be initially cooled for the interior. Since the second coolant circuit in turn is connected both to the chiller and to the drive train, waste heat from the drive train may be mixed with the cold coolant from the chiller, upstream from the high-voltage store. The mixing ratio between coolant from the drive train and coolant from the chiller is selectable based on the temperature requirements for the high-voltage store, so that an inlet temperature of the coolant flowing into the high-voltage store either heats or cools the high-voltage store or has the same temperature as the high-voltage store itself. Optionally, the above-mentioned heater may additionally deliver heat to the coolant, so that particularly cold coolant, namely, when the chiller is operated with very high cooling power, may be appropriately warmed. In the first coolant circuit, the heat that has been withdrawn from the air in the surroundings, and from the drive train and optionally from the high-voltage store and optionally the above-mentioned heater, is then delivered via the first internal radiator to the interior in order to warm same.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a thermal system according to the invention in a process circuit diagram, with the thermal system in the first switching state,

FIG. 2 shows the example according to FIG. 1, with the thermal system in the second switching state,

FIG. 3 shows the example according to FIG. 1, with the thermal system in the third switching state,

FIG. 4 shows the example according to FIG. 1, with the thermal system in the fourth switching state,

FIG. 5 shows the example according to FIG. 1, with the thermal system in the fifth switching state,

FIG. 6 shows the example according to FIG. 1, with the thermal system in the sixth switching state,

FIG. 7 shows the example according to FIG. 1, with the thermal system in the seventh switching state,

FIG. 8 shows the example according to FIG. 1, with the thermal system in the eighth switching state,

FIG. 9 shows the example according to FIG. 1, with the thermal system in the ninth switching state,

FIG. 10 shows the example according to FIG. 1, with the thermal system in the tenth switching state,

FIG. 11 shows the example according to FIG. 1, with the thermal system in the eleventh switching state,

FIG. 12 shows the example according to FIG. 1, with the thermal system in the twelfth switching state,

FIG. 13 shows the example according to FIG. 1, with the thermal system in the thirteenth switching state, and

FIG. 14 shows the example according to FIG. 1, with the thermal system in the fourteenth switching state.

### DETAILED DESCRIPTION

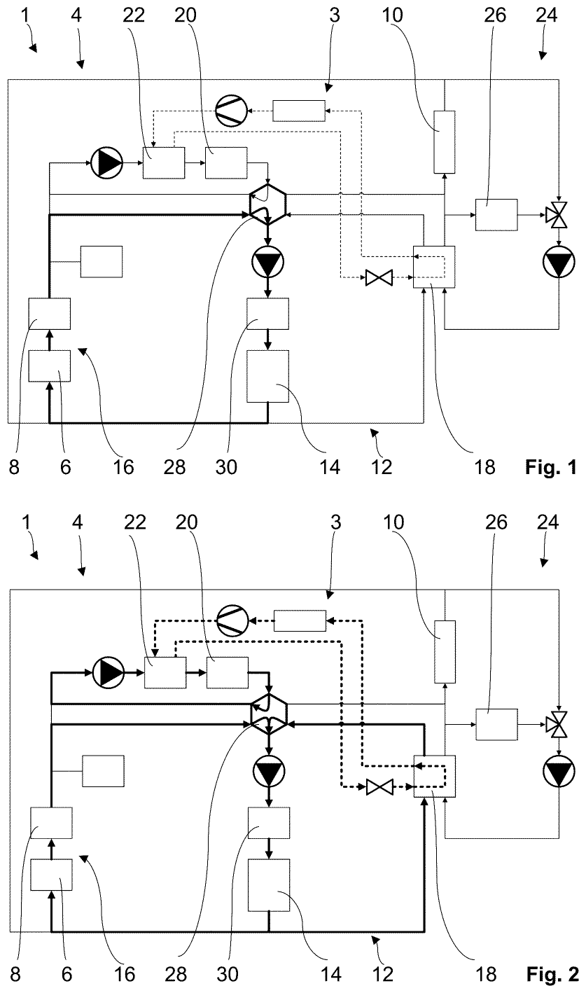

FIGS. 1 through 14 illustrate, strictly by way of example, an example of the thermal system can provide a total of fourteen switching states.

The thermal system 1 for an electric vehicle, comprises a refrigerant circuit 3, a first coolant circuit 4 to which two heat sources 6, 8 of the electric vehicle and, upstream from the heat sources 6, 8, an ambient cooler 10 of the electric vehicle for heat exchange with the free surroundings, are connected in a heat-transmitting manner, and a second coolant circuit 12 to which a high-voltage store 14 for supplying energy to an electric drive train 16 of the electric vehicle and a chiller 18 are connected in a heat-transmitting manner, wherein, the chiller 18 is also connected to the refrigerant circuit 3 in a heat-transmitting manner for heat transfer from the second coolant circuit 12 to the refrigerant circuit 3, and wherein a first switching state of the thermal system 1 is settable in which the second coolant circuit 12 is connected to the first coolant circuit 4 downstream from and upstream from the heat sources 6, 8, so that coolant may flow through the high-voltage store 14 and the heat sources 6, 8 in series for heating the high-voltage store 14 by means of the heat sources 6, 8. The first switching state of the thermal system 1 is illustrated in FIG. 1.

According to the invention, the thermal system 1 is designed in such a way that in addition to the first switching state of the thermal system 1, a second switching state of the thermal system 1 is settable in which, downstream from the high-voltage store 14, the second coolant circuit 12 is connected both to the heat sources 6, 8 and to the chiller 18, wherein coolant can flow through the heat sources 6, 8 and the chiller 18, which are connected in parallel. In this regard see FIG. 2, which illustrates the second switching state of the thermal system 1.

The heat sources 6, 8 here are designed in each case as a component of the drive train 16, namely, as an electric motor 8 for driving the electric vehicle which is supplied with energy by the high-voltage store 14, and power electronics 6 corresponding to the electric motor 8.

In addition, at the first coolant circuit 4 a first internal radiator 20 for heat transfer is connected to an interior of the electric vehicle in a heat-transmitting manner, wherein the first internal radiator 20 is selectively connectable to a remainder of the first coolant circuit 4 or is disconnectable from this remainder, and wherein a condenser 22 of the refrigerant circuit 3 is situated upstream from the first internal radiator 20 in a heat-transmitting manner.

In addition to the first and second coolant circuits 4, 12, the thermal system 1 has a third coolant circuit 24 to which, besides the chiller 18 and the ambient cooler 10, a second internal radiator 26 for heat transfer between the third coolant circuit 24 and the interior of the electric vehicle are connected in a heat-transmitting manner, wherein the second internal radiator 26 is selectively connectable to a remainder of the third coolant circuit 24 or is disconnectable from this remainder.

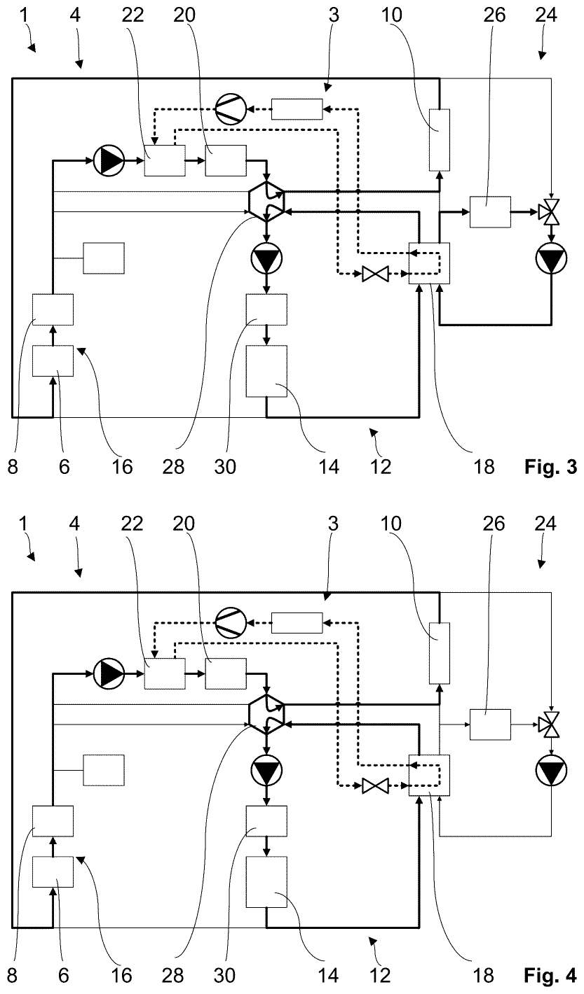

In addition to the first and second switching states of the thermal system 1 mentioned above, twelve further switching states of the thermal system 1 are achievable by use of a multiport valve 28. The individual switching states have already been described in detail in the introduction to the description, so that in the following discussion only a brief description of the further switching states of the thermal system 1 is provided, with reference to FIGS. 3 through 14. The coolant circuits through which coolant flows in the individual switching state of the thermal system 1 and coolant lines of the components of the thermal system 1 connected thereto are denoted in each case by thick, solid lines, while coolant circuits and coolant lines through which coolant does not flow are denoted by thin, solid lines. The refrigerant circuit 3 is illustrated with dashed lines in each of FIGS. 1 through 14. The particular flow direction is denoted in each case by an arrow.

FIG. 3 shows the third switching state of the thermal system 1, wherein in the third switching state, coolant can flow separately, firstly through the second coolant circuit 12 with the high-voltage store 14 and the chiller 18, secondly through the third coolant circuit 24 with the chiller 18 and the second internal radiator 26, and thirdly through the first coolant circuit 4 with the ambient cooler 10 and the drive train 16.

FIG. 4 shows the fourth switching state of the thermal system 1, wherein in the fourth switching state, coolant can flow separately, on the one hand through the second coolant circuit 12 with the high-voltage store 14 and the chiller 18, and on the other hand through the first coolant circuit 4 with the ambient cooler 10 and the drive train 16.

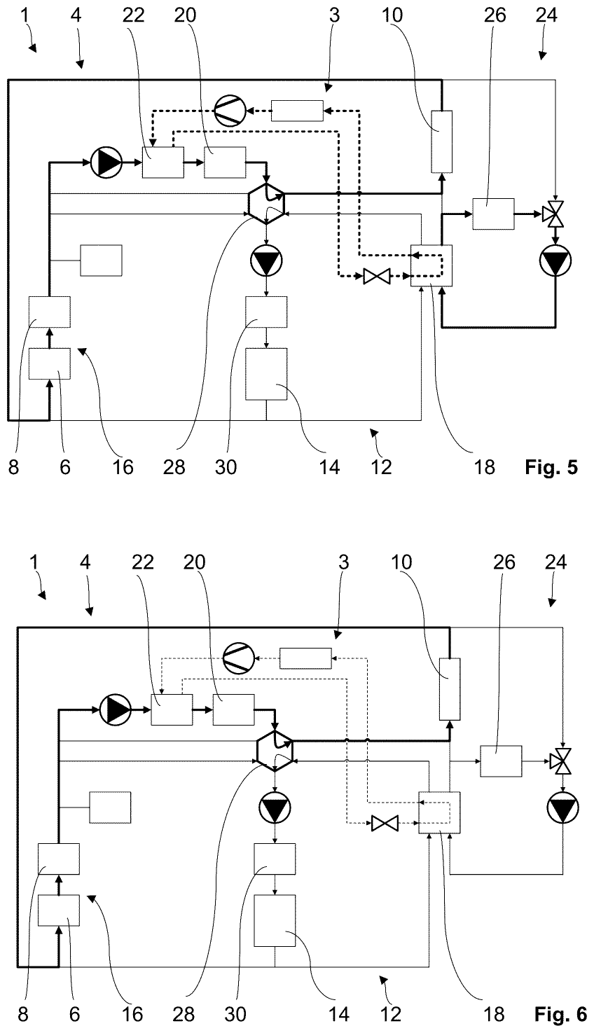

FIG. 5 shows the fifth switching state of the thermal system 1, wherein in the fifth switching state, coolant can flow separately, on the one hand through the third coolant circuit 24 with the chiller 18 and the second internal radiator 26, and on the other hand through the first coolant circuit 4 with the ambient cooler 10 and the drive train 16.

FIG. 6 shows the sixth switching state of the thermal system 1, wherein in the sixth switching state, coolant can flow only through the first coolant circuit 4 with the ambient cooler 10, and the drive train 16.

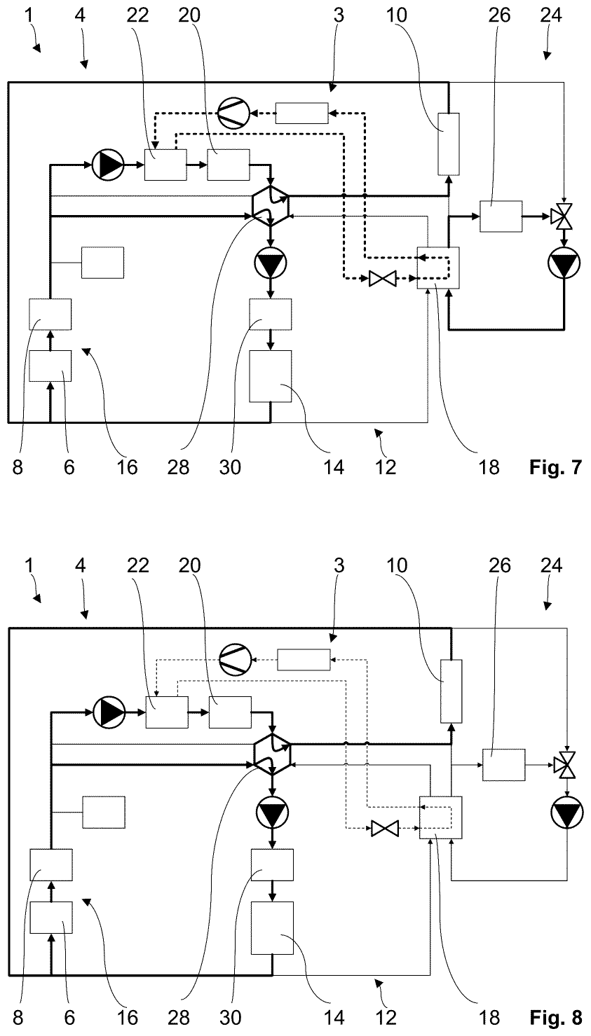

FIG. 7 shows the seventh switching state of the thermal system 1, wherein in the seventh switching state, coolant can flow on the one hand through the third coolant circuit 24 with the chiller 18 and the second internal radiator 26, and on the other hand coolant can flow jointly through the first coolant circuit 4 with the ambient cooler 10 and the drive train 16, and the second coolant circuit 12 which has the high-voltage store 14.

FIG. 8 shows the eighth switching state of the thermal system 1, wherein in the eighth switching state, the first coolant circuit 4 with the ambient cooler 10 and the drive train 16, and on the other hand the second coolant circuit 12 which has the high-voltage store 14, are connected to one another in a coolant-conducting manner by means of the drive train 16, and coolant can flow jointly through them.

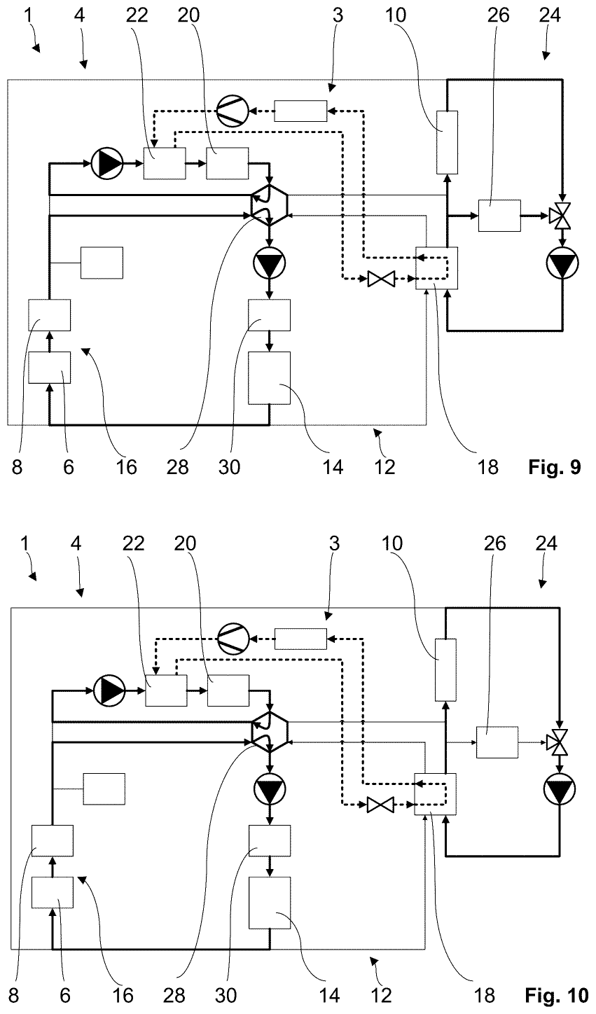

FIG. 9 shows the ninth switching state of the thermal system 1, wherein in the ninth switching state, coolant can flow separately, firstly through the third coolant circuit 24 with the second internal radiator 26, the ambient cooler 10, and the chiller 18, secondly through the second coolant circuit 12 which has the high-voltage store 14, together with the drive train, and thirdly, coolant can flow, separately therefrom, through the first internal radiator 20.

FIG. 10 shows the tenth switching state of the thermal system 1, wherein in the tenth switching state, coolant can flow separately, firstly through the third coolant circuit 24 with the chiller 18 and the ambient cooler 10, secondly through the second coolant circuit 12 which has the high-voltage store 14, together with the drive train 16, and thirdly, coolant can flow, separately therefrom, through the first internal radiator 20.

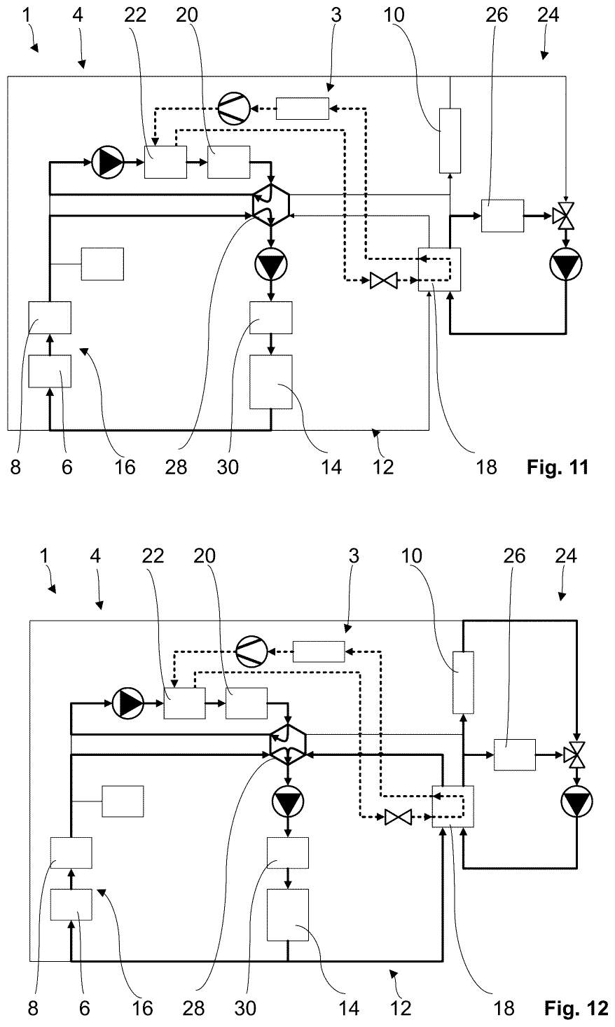

FIG. 11 shows the eleventh switching state of the thermal system 1, wherein in the eleventh switching state, coolant can flow separately, firstly through the third coolant circuit 24 with the chiller 18 and the second internal radiator 26, secondly through the second coolant circuit 12 which has the high-voltage store 14, together with the drive train 16, and thirdly, coolant can flow, separately therefrom, through the first internal radiator 20.

FIG. 12 shows the twelfth switching state of the thermal system 1, wherein in the twelfth switching state, coolant can flow separately, firstly through the third coolant circuit 24 with the chiller 18, the second internal radiator 26, and the ambient cooler 10, secondly through the second coolant circuit 12 which has the high-voltage store 14, together with the chiller 18 and the drive train 16, and thirdly, coolant can flow, separately therefrom, through the first internal radiator 20, and a heater 30 of the thermal system 1, namely, an electric auxiliary heater, for heating the coolant is connected to the second coolant circuit 12, upstream from the high-voltage store 14.

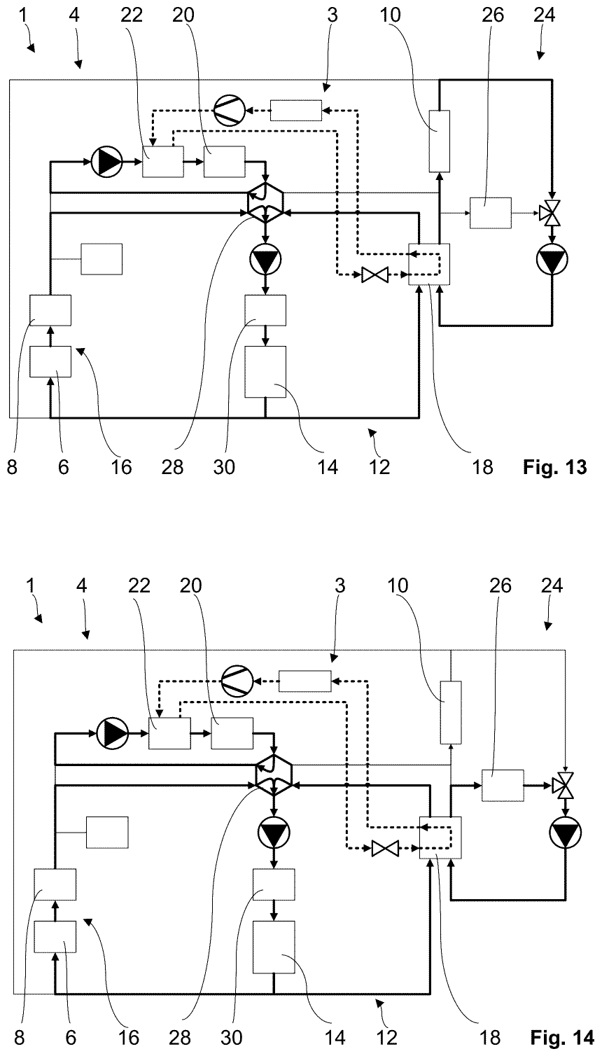

FIG. 13 shows the thirteenth switching state of the thermal system 1, wherein in the thirteenth switching state, coolant can flow separately, firstly through the third coolant circuit 24 with the chiller 18 and the ambient cooler 10, secondly through the second coolant circuit 12 which has the high-voltage store 14, together with the chiller 18 and the drive train 16, and thirdly, coolant can flow, separately therefrom, through the first internal radiator 20.

FIG. 14 shows the fourteenth switching state of the thermal system 1, wherein in the fourteenth switching state, coolant can flow separately, firstly through the third coolant circuit 24 with the chiller 18 and the second internal radiator 26, secondly through the second coolant circuit 12 which has the high-voltage store 14, together with the chiller 18 and the drive train 16, and thirdly, coolant can flow, separately therefrom, through the first internal radiator 20.

Due to the design according to the invention of the thermal system 1 for an electric vehicle, the heat that is withdrawn from the coolant system by the chiller 18 may be at least partially compensated for by the heat sources 6, 8, namely, by the drive train 16, so that the high-voltage store 14 may be either cooled or warmed by the coolant flowing out of the heat sources 6, 8 and into the chiller 18. In addition, the heat release by the heat sources 6, 8 and the heat withdrawal by the chiller 18 may be coordinated with one another in such a way that the coolant flowing into the high-voltage store 14 has the same temperature as that of the high-voltage store 14, and the high-voltage store 14 accordingly neither absorbs nor releases heat.

The invention is not limited to the present example. Mentioned as examples are the statements in this regard in the introduction to the description and in the explanation of the specific example. Accordingly, thermal systems according to the invention are also conceivable in which more or fewer switching states are achievable than in the present example. The same applies for the components of the thermal system according to the invention. Furthermore, the invention is not limited to the design and circuitry details of the specific example. For example, instead of the multiport valve a plurality of valves may be used to allow a comparable functionality of the thermal system according to the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A thermal system for an electric vehicle, the thermal system comprising:
a refrigerant circuit;
a first coolant circuit to which at least one heat source of the electric vehicle and, upstream from the heat source, an ambient cooler of the electric vehicle, are connected in a heat-transmitting manner for heat exchange with the free surroundings; and
a second coolant circuit to which a high-voltage store for supplying energy to an electric drive train of the electric vehicle, and a chiller are connected in a heat-transmitting manner, the chiller also being connected to the refrigerant circuit in a heat-transmitting manner for heat transfer from the second coolant circuit to the refrigerant circuit,
wherein a first switching state of the thermal system is settable in which, downstream from and upstream from the heat source, the second coolant circuit is connected to the first coolant circuit, so that coolant flows through the high-voltage store and the heat source in series for heating the high-voltage store via the heat source,
wherein, a second switching state of the thermal system is settable in which, downstream from the high-voltage store, the second coolant circuit is connected both to the heat source and to the chiller, so that coolant flows through the heat source and the chiller, which are connected in parallel.

2. The thermal system according to claim 1, wherein the heat source is a component of the drive train of the electric vehicle.

3. The thermal system according to claim 1, wherein at the first coolant circuit, a first internal radiator for heat transfer is connected to an interior of the electric vehicle in a heat-transmitting manner, and wherein the first internal radiator is selectively connectable to a remainder of the first coolant circuit or is disconnectable from this remainder, and wherein a condenser of the refrigerant circuit is situated upstream from the first internal radiator in a heat-transmitting manner.

4. The thermal system according to claim 1, wherein, in addition to the first and second coolant circuits, the thermal system further comprises a third coolant circuit to which, besides the chiller and the ambient cooler, a second internal radiator for heat transfer between the third coolant circuit and the interior of the electric vehicle is connected in a heat-transmitting manner, and wherein the second internal radiator is selectively connectable to a remainder of the third coolant circuit or is disconnectable from this remainder.

5. The thermal system according to claim 4, wherein the thermal system further comprises a third switching state of the thermal system that is settable, wherein in the third switching state, coolant flows separately, firstly through the second coolant circuit with the high-voltage store and the chiller, secondly through the third coolant circuit with the chiller and the second internal radiator, and thirdly through the first coolant circuit with the ambient cooler and the drive train.

6. The thermal system according to claim 2, wherein the thermal system further comprises a fourth switching state of the thermal system that is settable, wherein in the fourth switching state, coolant flows separately, through the second coolant circuit with the high-voltage store and the chiller and through the first coolant circuit with the ambient cooler and the drive train.

7. The thermal system according to claim 4, wherein the thermal system further comprises a fifth switching state of the thermal system that is is settable, wherein in the fifth switching state, coolant flows separately through the third coolant circuit with the chiller and the second internal radiator, and through the first coolant circuit with the ambient cooler and the drive train.

8. The thermal system according to claim 2, wherein the thermal system further comprises a sixth switching state of the thermal system that is settable, wherein in the sixth switching state, coolant flows only through the first coolant circuit with the ambient cooler and the drive train.

9. The thermal system according to claim 4, wherein the thermal system further comprises a seventh switching state of the thermal system that is settable, wherein in the seventh switching state, coolant flows through the third coolant circuit with the chiller and the second internal radiator, and the coolant flows jointly through the first coolant circuit with the ambient cooler and the drive train and the second coolant circuit which has the high-voltage store.

10. The thermal system according to claim 2, wherein the thermal system further comprises an eighth switching state of the thermal system that is settable, wherein in the eighth switching state, the first coolant circuit with the ambient cooler and the drive train and the second coolant circuit, which has the high-voltage store, are connected to one another in a coolant-conducting manner via the drive train such that the coolant flows jointly through them.

11. The thermal system according to claim 4, wherein the thermal system further comprises a ninth switching state of the thermal system that is settable, wherein in the ninth switching state, coolant flows separately, firstly through the third coolant circuit with the second internal radiator, the ambient cooler, and the chiller, secondly through the second coolant circuit that has the high-voltage store, together with the drive train, and thirdly, the coolant flows, separately therefrom, through the first internal radiator.

12. The thermal system according to claim 3, wherein the thermal system further comprises a tenth switching state of the thermal system that is settable, wherein in the tenth switching state, the coolant flows separately, firstly through the third coolant circuit with the chiller and the ambient cooler, secondly through the second coolant circuit that has the high-voltage store, together with the drive train, and thirdly, the coolant flows, separately therefrom, through the first internal radiator.

13. The thermal system according to claim 4, wherein the thermal system further comprises an eleventh switching state of the thermal system that is settable, wherein in the eleventh switching state, the coolant flows separately, firstly through the third coolant circuit with the chiller and the second internal radiator, secondly through the second coolant circuit that has the high-voltage store, together with the drive train, and thirdly, the coolant flows, separately therefrom, through the first internal radiator.

14. The thermal system according to claim 4, wherein the thermal system further comprises a twelfth switching state of the thermal system that is settable, wherein in the twelfth switching state, coolant flows separately, firstly through the third coolant circuit with the chiller, the second internal radiator, and the ambient cooler, secondly through the second coolant circuit that has the high-voltage store, together with the chiller and the drive train, and thirdly, the coolant flows, separately therefrom, through the first internal radiator, and a heater of the thermal system for heating the coolant that is connected to the second coolant circuit upstream from the high-voltage store.

15. The thermal system according to claim 3, wherein the thermal system further comprises a thirteenth switching state of the thermal system that is settable, wherein in the thirteenth switching state, coolant flows separately, firstly through the third coolant circuit with the chiller and the ambient cooler, secondly through the second coolant circuit that has the high-voltage store, together with the chiller and the drive train, and thirdly, the coolant flows, separately therefrom, through the first internal radiator and a heater of the thermal system for heating the coolant that is connected to the second coolant circuit upstream from the high-voltage store.

16. The thermal system according to claim 4, wherein the thermal system further comprises a fourteenth switching state of the thermal system that is settable, wherein in the fourteenth switching state, coolant flows separately, firstly through the third coolant circuit with the chiller and the second internal radiator, secondly through the second coolant circuit that has the high-voltage store, together with the chiller and the drive train, and thirdly, the coolant flows, separately therefrom, through the first internal radiator and a heater of the thermal system for heating the coolant that is connected to the second coolant circuit upstream from the high-voltage store.
